(19) United States
(12) Patent Application Publication
(10) Pub. No.: US 2021/0065218 A1
(43) Pub. Date: Mar. 4, 2021

(54) INFORMATION RECOMMENDATION METHOD AND DEVICE, AND STORAGE MEDIUM

(71) Applicant: BOE TECHNOLOGY GROUP CO., LTD., Beijing (CN)

(72) Inventors: Guohe WANG, Beijing (CN); Lei XU, Beijing (CN); Hui LI, Beijing (CN); Xibo ZHOU, Beijing (CN); Shaonan ZHANG, Beijing (CN)

(21) Appl. No.: 17/043,110

(22) PCT Filed: Jan. 14, 2020
(86) PCT No.: PCT/CN2020/072022

§ 371 Date: Sep. 29, 2020

(30) Foreign Application Priority Data
Jan. 14, 2019 (CN) 201910033469.8

(51) Int. Cl. G06Q 30/02; G06Q 30/06; G06F 16/9535; G06N 20/00

(52) U.S. Cl. CPC G06Q 30/0201; G06N 20/00; G06F 16/9535; G06Q 30/0631

(57) ABSTRACT

An information recommendation method and device and a storage medium. The information recommendation method includes: determining a target recommendation parameter corresponding to a page identifier of a page, according to the page identifier and a correspondence between a page identifier and a recommendation parameter; determining a corresponding target recommendation strategy according to the target recommendation parameter; querying a correspondence between a recommendation strategy and a recommendation result according to the target recommendation strategy, so as to obtain at least one initial recommendation result; and fusing the at least one initial recommendation result according to a corresponding weight to obtain a target recommendation result.

### CROSS-REFERENCE TO RELATED APPLICATION

The present application claims priority to Chinese Patent Application No. 201910033469.8, filed on Jan. 14, 2019, the disclosure of which is incorporated herein by reference in its entirety as part of the present application.

### TECHNICAL FIELD

Embodiments of the present disclosure relate to an information recommendation method and device, and a storage medium.

### BACKGROUND

With the development of an information technology and the Internet, the human society is developed from an information shortage era to an information overload era. It becomes increasingly difficult for an information consumer to find information of interest from a large amount of information and for an information producer to make produced information stand out from a lot of information.

In related art, information may be recommended to a user when the user browses information, so as to assist the user in finding information of interest quickly. However, how to improve pertinence of information recommendation is a technical problem to be solved.

### SUMMARY

At least one embodiment of the present disclosure provides an information recommendation method, which includes:

determining a target recommendation parameter corresponding to a page identifier of a page, according to the page identifier and a correspondence between a page identifier and a recommendation parameter;

determining a corresponding target recommendation strategy according to the target recommendation parameter;

querying a correspondence between a recommendation strategy and a recommendation result according to the target recommendation strategy, so as to obtain at least one initial recommendation result; and

fusing the at least one initial recommendation result according to a corresponding weight to obtain a target recommendation result.

In an embodiment, the page is a first recommendation page; and the target recommendation parameter is a user identifier of a user.

In an embodiment, the target recommendation strategy is a first recommendation strategy;

the querying the correspondence between the recommendation strategy and the recommendation result according to the target recommendation strategy, so as to obtain the at least one initial recommendation result comprises:

obtaining a first initial recommendation result, a second initial recommendation result and a third initial recommendation result, according to the first recommendation strategy;

wherein the first initial recommendation result is a target recommended to the user according to target preference data of the user corresponding to the user identifier;

the second initial recommendation result is a target recommended to the user according to a tag of the user corresponding to the user identifier; and

the third initial recommendation result is a target recommended to the user according to a put-on-sale time of the target and the user identifier, and the put-on-sale time meets a preset condition.

In an embodiment, prior to determining the corresponding target recommendation strategy according to the target recommendation parameter, the information recommendation method further comprises:

determining according to the user identifier that user-target interaction behavior data corresponding to the user identifier exists in a preset database, and

the target preference data is obtained according to the user-target interaction behavior data corresponding to the user identifier.

In an embodiment, the target recommendation strategy is a second recommendation strategy;

the querying the correspondence between the recommendation strategy and the recommendation result according to the target recommendation strategy, so as to obtain the at least one initial recommendation result comprises:

obtaining a second initial recommendation result and a third initial recommendation result, according to the second recommendation strategy;

wherein the second initial recommendation result is a target recommended to the user according to a tag of the user corresponding to the user identifier; and

the third initial recommendation result is a target recommended to the user according to a put-on-sale time of the target and the user identifier, and the put-on-sale time meets a preset condition.

In an embodiment, prior to determining the corresponding target recommendation strategy according to the target recommendation parameter, the information recommendation method further comprises:

determining according to the user identifier that user-target interaction behavior data corresponding to the user identifier is absent in a preset database.

In an embodiment, the page is a second recommendation page; and the target recommendation parameter comprises a target identifier and a user identifier of a user.

In an embodiment, the target recommendation strategy is a third recommendation strategy;

the querying the correspondence between the recommendation strategy and the recommendation result according to the target recommendation strategy, so as to obtain the at least one initial recommendation result comprises:

obtaining a first initial recommendation result, a fourth initial recommendation result and a fifth initial recommendation result, according to the third recommendation strategy;

wherein the first initial recommendation result is a target recommended to the user according to target preference data of the user corresponding to the user identifier;

the fourth initial recommendation result is a target recommended to the user according to a first correspondence between the target identifier and a target identifier of a similar target, and the target preference data and the first correspondence are obtained according to user-target interaction behavior data corresponding to the user identifier; and

the fifth initial recommendation result is a target recommended to the user according to the target identifier and a second correspondence between the target identifier and a target identifier of a similar target, and the second correspondence is obtained by calculating a similarity between targets according to attribute data of the targets.

In an embodiment, prior to determining the corresponding target recommendation strategy according to the target recommendation parameter, the information recommendation method further comprises:

determining according to the user identifier that the user-target interaction behavior data corresponding to the user identifier exists in a preset database; and

determining according to the target identifier that target interaction behavior data corresponding to the target identifier exists in a preset database.

In an embodiment, the target recommendation strategy is a fourth recommendation strategy;

the querying the correspondence between the recommendation strategy and the recommendation result according to the target recommendation strategy, so as to obtain the at least one initial recommendation result comprises:

obtaining a first initial recommendation result and a fifth initial recommendation result, according to the fourth recommendation strategy;

wherein the first initial recommendation result is a target recommended to the user according to target preference data of the user, and the target preference data is obtained by inputting user-target interaction behavior data into a trained recommendation model; and

the fifth initial recommendation result is a target recommended to the user according to the target identifier and a second correspondence between the target identifier and a target identifier of a similar target, and the second correspondence is obtained by calculating a similarity between targets according to attribute data of the targets.

In an embodiment, prior to determining the corresponding target recommendation strategy according to the target recommendation parameter, the information recommendation method further comprises:

determining according to the user identifier that the user-target interaction behavior data corresponding to the user identifier exists in a preset database; and

determining according to the target identifier that target interaction behavior data corresponding to the target identifier is absent in a preset database.

In an embodiment, the target recommendation strategy is a fifth recommendation strategy;

the querying the correspondence between the recommendation strategy and the recommendation result according to the target recommendation strategy, so as to obtain the at least one initial recommendation result comprises:

obtaining a fourth initial recommendation result and a fifth initial recommendation result, according to the fifth recommendation strategy;

wherein the fourth initial recommendation result is the target recommended to the user according to a first correspondence between the target identifier and a target identifier of a similar target, and the first correspondence is obtained according to user-target interaction behavior data corresponding to the user identifier; and

the fifth initial recommendation result is a target recommended to the user according to the target identifier and a second correspondence between the target identifier and a target identifier of a similar target, and the second correspondence is obtained by calculating a similarity between targets according to attribute data of the targets.

In an embodiment, prior to determining the corresponding target recommendation strategy according to the target recommendation parameter, the information recommendation method further comprises:

determining according to the user identifier that user-target interaction behavior data corresponding to the user identifier is absent in a preset database; and

determining according to the target identifier that target interaction behavior data corresponding to the target identifier exists in a preset database.

In an embodiment, the target recommendation strategy is a sixth recommendation strategy;

the querying the correspondence between the recommendation strategy and the recommendation result according to the target recommendation strategy, so as to obtain the at least one initial recommendation result comprises:

obtaining a fifth initial recommendation result according to the sixth recommendation strategy;

wherein the fifth initial recommendation result is a target recommended to the user according to the target identifier and a second correspondence between the target identifier and a target identifier of a similar target, and the second correspondence is obtained by calculating a similarity between targets according to attribute data of the targets.

In an embodiment, prior to determining the corresponding target recommendation strategy according to the target recommendation parameter, the information recommendation method further comprises:

determining according to the user identifier that user-target interaction behavior data corresponding to the user identifier is absent in a preset database; and

determining according to the target identifier that target interaction behavior data corresponding to the target identifier is absent in a preset database.

In an embodiment, the user-target interaction behavior data comprises at least one of a group consisting of target purchase behavior data, target commenting behavior data, target sharing behavior data, target collecting behavior data, target likes-giving behavior data, target browsing behavior data and target pushing behavior data.

In an embodiment, the target interaction behavior data comprises at least one of a group consisting of target purchase behavior data, target commenting behavior data, target sharing behavior data, target collecting behavior data, target likes-giving behavior data, target browsing behavior data and target pushing behavior data.

In an embodiment, obtaining at least one initial recommendation result according to the target recommendation strategy comprises:

obtaining the at least one initial recommendation result from a database according to the target recommendation strategy, wherein the at least one initial recommendation result is stored in the database in advance.

At least one embodiment of the present disclosure further provides an information recommendation device, which includes:

a first determining module configured to determine a target recommendation parameter corresponding to a page identifier of a page, according to the page identifier and a correspondence between a page identifier and a recommendation parameter;

a second determining module configured to determine a corresponding target recommendation strategy according to the target recommendation parameter;

a querying module configured to query a correspondence between a recommendation strategy and a recommendation result according to the target recommendation strategy, so as to obtain at least one initial recommendation result; and

a fusing module configured to fuse the at least one initial recommendation result according to a corresponding weight to obtain a target recommendation result.

At least one embodiment of the present disclosure further provides an information recommendation device, which includes:

a processor; and

a memory,

wherein the memory is configured to store instructions, and the instructions, when executed by the processor, cause the processor to execute operations comprising:

determining a target recommendation parameter corresponding to a page identifier of a page, according to the page identifier and a correspondence between a page identifier and a recommendation parameter;

determining a corresponding target recommendation strategy according to the target recommendation parameter;

querying a correspondence between a recommendation strategy and a recommendation result according to the target recommendation strategy, so as to obtain at least one initial recommendation result; and

fusing the at least one initial recommendation result according to a corresponding weight to obtain a target recommendation result.

At least one embodiment of the present disclosure further provides a non-transitory computer storage medium configured to store instructions, the instructions, when executed by a processor, causing the processor to execute operations comprising:

determining a target recommendation parameter corresponding to a page identifier of a page, according to the page identifier and a correspondence between a page identifier and a recommendation parameter;

determining a corresponding target recommendation strategy according to the target recommendation parameter;

querying a correspondence between a recommendation strategy and a recommendation result according to the target recommendation strategy, so as to obtain at least one initial recommendation result; and

fusing the at least one initial recommendation result according to a corresponding weight to obtain a target recommendation result.

It should be understood that the above general description and the following detailed description are only illustrative and explanatory, and cannot be construed to limit the embodiments of the present disclosure.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a schematic structural diagram of a recommendation system according to at least one embodiment of the present disclosure;

FIG. 2 is a flow chart of an information recommendation method according to at least one embodiment of the present disclosure;

FIG. 3 is a block diagram of an information recommendation device according to at least one embodiment of the present disclosure; and

FIG. 4 is a block diagram of an information recommendation device according to at least one embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Hereinafter, embodiments of the present disclosure will be described by taking recommendation of a commodity to a user as an example. However, it should be understood that in other embodiments, in addition to commodities, targets recommended to the user may include, for example, news, videos, music, paintings, etc., which is not limited in the embodiments of the present disclosure.

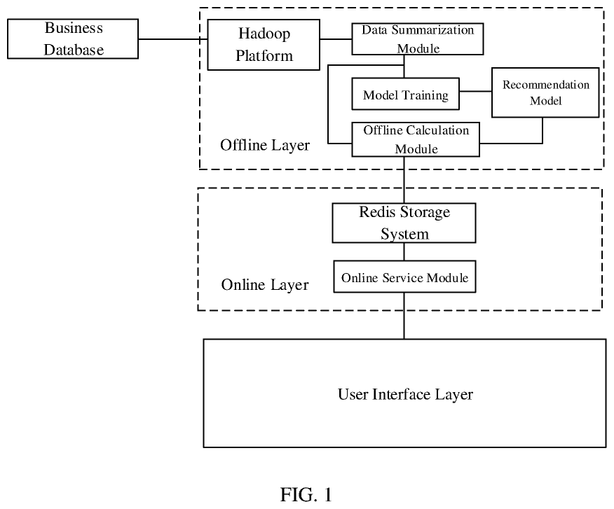

At least one embodiment of the present disclosure provides an information recommendation method which may be applied to a recommendation system as shown in FIG. 1. The recommendation system may be applied to a news website, a news application, a shopping website, a shopping application, a video website, a music application, etc., which is not limited in the embodiments of the present disclosure. Before describing the information recommendation method according to the embodiments of the present disclosure, the recommendation system shown in FIG. 1 will be described below. It should be understood that the recommendation system shown in FIG. 1 is only an example, and the information recommendation method according to the present disclosure may also be applied to a recommendation system providing other results, which is not limited in the embodiments of the present disclosure.

In an embodiment, as shown in FIG. 1, the recommendation system may include an offline layer, an online layer and a user interface (UI) layer. The offline layer is used to store data, train a recommendation model with the stored data to obtain a trained recommendation model, obtain at least one initial recommendation result by using the stored data, the trained recommendation model and a preset algorithm, and output the obtained at least one initial recommendation result to the online layer for storage. The online layer is used to store the at least one initial recommendation result, and further to determine a corresponding target recommendation parameter according to a current page displayed by the UI layer, determine a corresponding target recommendation strategy according to the target recommendation parameter, acquire corresponding at least one initial recommendation result from the stored at least one initial recommendation result according to the target recommendation strategy, and fuse the acquired at least one initial recommendation result according to a corresponding weight to obtain a target recommendation result. The online layer is also used to output the target recommendation result to the UI layer to be displayed to the user.

In an embodiment, the data stored in the offline layer may be updated according to a preset period based on data stored in a business database. The business database may be created in a server of the recommendation system. Business data may be stored in the business database, and include user data, commodity attribute data, user-commodity interaction behavior data and commodity interaction behavior data. The user-commodity interaction behavior data may include at least one of commodity purchase behavior data, commodity commenting behavior data, commodity sharing behavior data, commodity collecting behavior data, commodity likes-giving behavior data, commodity browsing behavior data and commodity pushing behavior data. The commodity interaction behavior data may include at least one of commodity purchase behavior data, commodity commenting behavior data, commodity sharing behavior data, commodity collecting behavior data, commodity likes-giving behavior data, commodity browsing behavior data and commodity pushing behavior data. For example, the commodity purchase behavior data may be saved in an order table, and the commodity sharing behavior data may be saved in a sharing table. The user data may include user tags which may be saved in a user tag table. The commodity attribute data may include commodity tags which may be saved in a commodity tag table.

In an embodiment, a Hadoop platform may be adopted as the offline layer, and the data may be stored with a Hadoop Distributed File System (HDFS) in the Hadoop platform. After imported into the Hadoop platform from the business database, the data may be summarized by a data summarization module. Specifically, one database table may be stored in one folder, a plurality of files are arranged in the folder for storing the data in a text file with commas as separators, and the storage folders of all the database tables may be stored in a general folder.

In the offline layer, before summarization of the data, operations of screening, deduplication, optimization, etc., may also be performed on the data, which is not limited in the embodiments of the present disclosure.

It should be understood that in other embodiments, the offline layer may also be implemented using other types of platforms (for example, non-distributed storage platforms), which is not limited in the embodiments of the present disclosure.

In an embodiment, the data imported from the business database may be processed by the offline layer using a preset algorithm and the trained recommendation model, so as to obtain the at least one initial recommendation result. In an exemplary embodiment, the at least one initial recommendation result may include a first initial recommendation result, a second initial recommendation result, a third initial recommendation result, a fourth initial recommendation result and a fifth initial recommendation result. The first initial recommendation result is a commodity recommended to the user according to commodity preference data of the user. The second initial recommendation result is a commodity recommended to the user according to the tag of the user and a correspondence between the commodity and the tag. The third initial recommendation result is a commodity recommended to the user according to the put-on-sale time of the commodity and a user identifier and having a put-on-sale time meeting a preset condition. The fourth initial recommendation result is a commodity recommended to the user according to a first correspondence between a commodity identifier and a commodity identifier of a similar commodity. The fifth initial recommendation result is a commodity recommended to the user according to a commodity identifier and a second correspondence between the commodity identifier and a commodity identifier of a similar commodity, and the second correspondence is obtained by calculating a similarity between the commodities according to the commodity attribute data. The commodity preference data and the first correspondence are obtained by inputting the user-commodity interaction behavior data into the trained recommendation model.

A method of obtaining the first and fourth initial recommendation results by an offline calculation module in the offline layer using the trained recommendation model is described below. The user-commodity interaction behavior data is input into and processed by the trained recommendation model to obtain a preference value of each user for each commodity and the similarity between the commodities, and the preference value of each user for each commodity is the commodity preference data of the user. Then, the first initial recommendation result of the commodity recommended to the user may be generated according to the commodity preference data of the user. Meanwhile, the first correspondence between a commodity identifier and the commodity identifier of a similar commodity may be obtained according to the similarity between the commodities, and the fourth initial recommendation result of the commodity recommended to the user may be obtained according to the first correspondence.

A training method of the recommendation model is described below. The recommendation model may be trained by a model training module in the offline layer using a part of the stored data as a training set and a verification set, so as to obtain the trained recommendation model. In an embodiment, the recommendation model may be based on a collaborative filtering recommendation algorithm. In this embodiment, the user-commodity interaction behavior data may be read from the Hadoop platform, and preprocessed to obtain pure user-commodity interaction behavior data which is then synthesized, subjected to format conversion, and deduplicated to obtain deduplicated user-commodity interaction behavior data. Then, the deduplicated user-commodity interaction behavior data is divided into a training set, a verification set and a test set according to a time stamp, but the division of the data sets is not limited thereto. Then, the recommendation model based on the collaborative filtering recommendation algorithm is trained with the training set and the verification set to determine hyperparameters of the recommendation model, so as to obtain a trained recommendation model based on the collaborative filtering recommendation algorithm. The hyperparameters are parameters set before the recommendation model is trained, rather than parameters obtained by the training process.

In an exemplary embodiment, the user-commodity interaction behavior data may be a score matrix R of the user for the commodity. In the process of training the recommendation model based on the collaborative filtering recommendation algorithm, the score matrix R may be decomposed into two low-dimensional matrices p, q, the matrix p is a factor matrix of the user, and the matrix q is a factor matrix of the commodity. In the matrix p, each matrix element is the preference value of the user for the commodity, each row corresponds to one user, and each column corresponds to a hidden attribute (latent factor). The hidden attribute may have no actual or specific meaning and no interpretability, and is used for describing an attribute of the commodity. In the matrix q, each matrix element is a weight value of the commodity, each row corresponds to one commodity, and each column corresponds to a hidden attribute (latch factor). An unknown score in the score matrix R may be calculated by multiplying the two low-dimensional matrices p, q. The product of the two low-dimensional matrices p, q may be represented by \hat{R}, and the score matrix R is approximately equal to \hat{R}. A relationship between the two low-dimensional matrices p, q, the score matrix R and \hat{R} may be seen in the following formula (1):

R≈\hat{R}=p^{T}q (1)

In the above-mentioned exemplary embodiment, the matrix may be decomposed by solving the following loss function (2):

$$min C ( p , q ) = min {\sum }_{( u , i ) ∈ Train} {( {r}_{ui} - {\sum }_{f = 1}^{F} {p}_{uf} {q}_{if} )}^{2} + λ ( {‖ {p}_{u} ‖}^{2} + {‖ {q}_{i} ‖}^{2} ) \qquad ( 2 )$$

where u is the user identifier, i is the commodity identifier, rᵤᵢ is the known score of the user u for the commodity i, p and q represent the factor matrices of the user and the commodity respectively, which represent values of each user and each commodity on each feature of the corresponding factor matrix respectively, f is the number of columns of the matrices p, q, F is the total number of the columns of the matrices p, q, i.e., the total number of the features, and Train is the training set. A second term in the loss function (2) is a regularization term, λ is a coefficient before the regularization term, and the regularization term is added into the loss function to prevent overfitting and control the complexity of the model. The more complex the model is, the larger the regularization value is, and λ is greater than or equal to 0.

In the above-mentioned exemplary embodiment, optimal solutions p, q, i.e., the decomposed low-dimensional matrices, may be calculated with a stochastic gradient descent method or an alternating least squares (ALS) method. After the low-dimensional matrices p, q are obtained, a prediction score of the user u for the commodity j, i.e., the preference value of the user u for the commodity j, may be obtained with the following formula (3), and a value of the similarity between the commodities i, j may be obtained with the following formula (4):

\hat{r}ᵤⱼ=pᵤ^{T}qⱼ (3)

wᵢⱼ=qᵢqⱼ (4)

In the above-mentioned exemplary embodiment, an accuracy rate and a recall rate may be calculated with the test set to determine whether the recommendation model meets requirements. The accuracy rate is a proportion that the commodities with interaction behaviors recommended to the user in the test set account for in all the commodities with interaction behaviors, and the recall rate is a proportion that the commodities with interaction behaviors recommended to the user in the test set account for in all the recommendation results.

In the above-mentioned exemplary embodiment, the trained recommendation model is obtained after the recommendation model is determined to meet requirements. The commodity preference data of the user may be obtained using the trained recommendation model and the above-mentioned formula (3), and the first initial recommendation result of the commodity recommended to the user may be generated according to the commodity preference data of the user. The first correspondence between the commodity identifier of the and the commodity of the similar commodity may be obtained using the trained recommendation model and the above-mentioned formula (4), and the fourth initial recommendation result of the commodity recommended to the user may be generated according to the first correspondence between the commodity identifier and the commodity identifier of the similar commodity.

A method of obtaining the second initial recommendation result by using a tag-based recommendation algorithm is described below. First, partial attribute data of the commodity may be extracted from the attribute data of the commodity in a preset commodity database. When some attribute data of the commodity is extracted from the attribute data of the commodity, the attribute data of the commodity with a specified tag may be extracted randomly, or the partial attribute data of the commodity may be extracted according to other data extraction methods. Then, the commodities purchased by each user are counted. Next, for each user, the purchased commodities are filtered out from the commodity database to obtain a filtered commodity database. Then, for each user, the filtered commodity database are searched for the commodities with the commodity tags completely or partially identical to the tag of the user according to the tag of the user, so as to obtain a first commodity set. Then, for each user, the commodity recommended to the user is extracted from the first commodity set to obtain the second initial recommendation result. When the commodity recommended to the user is extracted from the first commodity set, a specified number of commodities may be extracted randomly, or the commodity may be extracted according to other data extraction methods.

A method of obtaining the third initial recommendation result by using a new-commodity-based recommendation algorithm is described below. A new commodity has a time interval between the put-on-sale time and the current time below a preset threshold. First, the commodities with the put-on-sale time meeting a preset condition are extracted from the attribute data of the commodities according to the put-on-sale time of the commodities, so as to obtain a second commodity set. The attribute data of the commodities includes the put-on-sale time. The preset condition may be that the time interval between the put-on-sale time and the current time is below the preset threshold. Then, the commodities purchased by each user are counted. Next, for each user, the purchased commodities are filtered out from the second commodity set to obtain a third commodity set. Then, for each user, the commodity recommended to the user is extracted from the third commodity set to obtain the third initial recommendation result. When the commodity recommended to the user is extracted from the third commodity set, a specified number of commodities may be extracted randomly, or the commodity may be extracted according to other data extraction methods.

A method of obtaining the fifth initial recommendation result by using a content-based recommendation algorithm is described below. First, the attribute data of each commodity may be converted into a vector M. In an exemplary embodiment, a multi-hot conversion may be performed on the attribute data of each commodity to obtain the vector M. That is, multiple values of a single feature are converted into the vector M, a position including a feature value has a value of 1, and other positions have a value of 0. In an exemplary embodiment, the commodity may be a painting, a movie, a book, or the like. The attribute data of the commodity may include subject data and type data thereof. Then, the similarity between the commodities is calculated according to the vector corresponding to each commodity. In an exemplary embodiment, the similarity between the commodities may be calculated using the Jaccard similarity coefficient algorithm. For example, wᵢⱼ is the similarity between the commodities i, j, and may be calculated by the following formula (5). In the Jaccard similarity coefficient algorithm, only set operation is performed, numerical values are ignored, and the data only includes 0 and 1, with a calculation efficiency which is relatively high. Then, for each commodity, a specified number of commodities with the highest similarity are taken as the recommendation result, i.e., the fifth initial recommendation result.

wᵢⱼ=Mᵢ·Mⱼ (5)

In the above-mentioned exemplary embodiment, the above-mentioned first, second, third, fourth and fifth initial recommendation results may be output to the online layer by the offline layer for storage. In an exemplary embodiment, the first, second, third, fourth and fifth initial recommendation results received from the offline layer may be stored by using a remote dictionary server (Redis) storage system of the online layer. The received data is stored in the Redis storage system in a key-value format. For example, in the fifth initial recommendation result, key is the commodity identifier of the commodity, and value is a set of the commodity identifiers of the commodities in the recommendation result. For example, the Redis storage system includes a Redis database.

It should be understood that in other embodiments, at least one of the first, second, third, fourth and fifth initial recommendation results may also be stored by using other types of databases, which is not limited in the embodiments of the present disclosure.

In an embodiment, the online layer includes an online service module which is used to provide online services. For example, the online service module may determine the corresponding target recommendation parameter according to the current page displayed by the UI layer, determine the corresponding target recommendation strategy according to the target recommendation parameter, acquire the corresponding at least one initial recommendation result from the stored at least one initial recommendation result according to the target recommendation strategy, and fuse the acquired at least one initial recommendation result according to the corresponding weight to obtain the target recommendation result. The online layer is also used to output the target recommendation result to the UI layer. The UI layer may output the target recommendation result, for example, display the target recommendation result in a preset area in the current page.

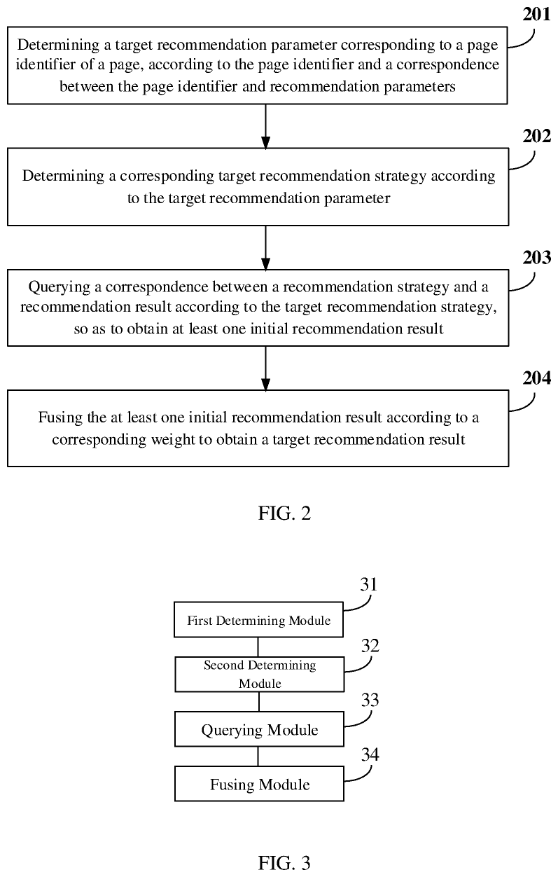

The recommendation system according to the embodiments of the present disclosure has been described above, and the information recommendation method according to the embodiments of the present disclosure is described below. The information recommendation method may be applied to a terminal equipment which may be a server, for example, or to a system including a server and a client as well. The following description is made by taking applying the information recommendation method to a server as an example. As shown in FIG. 2, the information recommendation method may include the following steps 201-204.

Step 201: determining a target recommendation parameter corresponding to a page identifier of a page, according to the page identifier and a correspondence between the page identifier and recommendation parameters.

In an embodiment, the page may be a first recommendation page or a second recommendation page. The first and second recommendation pages correspond to different recommendation parameters respectively. The first recommendation page corresponds to the recommendation parameter which is a user identifier, and the recommendation parameter of the second recommendation page includes a user identifier and a commodity identifier. The correspondence between the page identifier and the recommendation parameter may be stored in the server in advance. In an embodiment, each page for displaying information corresponds to a page identifier. When a user browses the information at the page, the target recommendation parameter corresponding to the page identifier of the page may be determined according to the page identifier and the correspondence between the page identifier and the recommendation parameter.

In an exemplary scenario, the information recommendation method according to the embodiments of the present disclosure is applied to a painting application. The painting application is application software for selling paintings and may provide a first recommendation page and a second recommendation page. The first recommendation page may display at least one recommended painting. The second recommendation page may display detailed information of the painting, for example, the number of “likes”, a comment, a price, a name, a brief introduction, a tag, etc. The page identifier of the first recommendation page may be P01, and the page identifier of the second recommendation page may be P02.

Continuing with the above-mentioned exemplary scenario, the correspondence between the page identifier and the recommendation parameter stored in the server in advance may be shown in table 1 below. When the page identifier of the current page is P01, the table 1 is looked up according to P01, and the target recommendation parameter is the user identifier.

TABLE 1

| Page Identifier | Recommendation Parameter |
|---|---|
| P01 | User Identifier |
| P02 | User Identifier and Commodity Identifier |

Step 202: determining a corresponding target recommendation strategy according to the target recommendation parameter.

In an exemplary embodiment, in the case where the target recommendation parameter is the user identifier, if user-commodity interaction behavior data corresponding to the user identifier exists in a database preset in the server, a first recommendation strategy is determined as the corresponding target recommendation strategy. In the case where the target recommendation parameter is the user identifier, if the user-commodity interaction behavior data corresponding to the user identifier does not exist in the database preset in the server, a second recommendation strategy is determined as the corresponding target recommendation strategy.

In another exemplary embodiment, the target recommendation parameter includes the user identifier and the commodity identifier. In the case where the user-commodity interaction behavior data corresponding to the user identifier and the commodity interaction behavior data corresponding to the commodity identifier exist in the preset database, a third recommendation strategy is determined as the corresponding target recommendation strategy. In the case where the user-commodity interaction behavior data corresponding to the user identifier exists in the preset database and the commodity interaction behavior data corresponding to the commodity identifier does not exist in the preset database, a fourth recommendation strategy is determined as the corresponding target recommendation strategy. When the user-commodity interaction behavior data corresponding to the user identifier does not exist in the preset database and the commodity interaction behavior data corresponding to the commodity identifier exists in the preset database, a fifth recommendation strategy is determined as the corresponding target recommendation strategy. When the user-commodity interaction behavior data corresponding to the user identifier and the commodity interaction behavior data corresponding to the commodity identifier do not exist in the preset database, a sixth recommendation strategy is determined as the corresponding target recommendation strategy.

In an embodiment, the current page is the first recommendation page, the target recommendation parameter is the user identifier, and a correspondence between the user identifier and the user-commodity interaction behavior data is stored in the database. In this embodiment, before the step 202, if the user-commodity interaction behavior data corresponding to the user identifier is determined to exist in the preset database according to the user identifier, the first recommendation strategy is determined as the corresponding target recommendation strategy.

Before the step 202, if the user-commodity interaction behavior data corresponding to the user identifier is determined not to exist in the preset database according to the user identifier, the second recommendation strategy is determined as the corresponding target recommendation strategy.

In an embodiment, the current page is the second recommendation page, the target recommendation parameter includes the user identifier and the commodity identifier, and the correspondence between the user identifier and the user-commodity interaction behavior data as well as a correspondence between the commodity identifier and the commodity interaction behavior data are stored in the database. In this embodiment, before the step 202, if the user-commodity interaction behavior data corresponding to the user identifier is determined to exist in the preset database according to the user identifier, and the commodity interaction behavior data corresponding to the commodity identifier is determined to exist in the preset database according to the commodity identifier, the third recommendation strategy is determined as the corresponding target recommendation strategy.

Before the step 202, if the user-commodity interaction behavior data corresponding to the user identifier is determined to exist in the preset database according to the user identifier, and the commodity interaction behavior data corresponding to the commodity identifier is determined not to exist in the preset database according to the commodity identifier, the fourth recommendation strategy is determined as the corresponding target recommendation strategy.

Before the step 202, if the user-commodity interaction behavior data corresponding to the user identifier is determined not to exist in the preset database according to the user identifier, and the commodity interaction behavior data corresponding to the commodity identifier is determined to exist in the preset database according to the commodity identifier, the fifth recommendation strategy is determined as the corresponding target recommendation strategy.

Before the step 202, if the user-commodity interaction behavior data corresponding to the user identifier is determined not to exist in the preset database according to the user identifier, and the commodity interaction behavior data corresponding to the commodity identifier is determined not to exist in the preset database according to the commodity identifier, the sixth recommendation strategy is determined as the corresponding target recommendation strategy.

TABLE 2

| Recommendation Strategy | Recommendation Result |
|---|---|
| First Recommendation | First, Second and Third Initial |
| Strategy | Recommendation Results |
| Second Recommendation | Second and Third Initial Recommendation |
| Strategy | Results |
| Third Recommendation | First, Fourth and Fifth Initial |
| Strategy | Recommendation Results |
| Fourth Recommendation | First and Fifth Initial Recommendation |
| Strategy | Results |
| Fifth Recommendation | Fourth and Fifth Initial Recommendation |
| Strategy | Results |
| Sixth Recommendation | Fifth Initial Recommendation Result |
| Strategy | |

Step 203: obtaining at least one initial recommendation result according to the target recommendation strategy.

In an embodiment, a correspondence between the recommendation strategy and the recommendation result may be stored in the server in advance and is shown in table 2. The corresponding at least one initial recommendation result may be obtained by the server looking up the table 2 according to the target recommendation strategy. For example, in the case where the first recommendation strategy is the target recommendation strategy, the table 2 may be looked up to obtain a first initial recommendation result, a second initial recommendation result and a third initial recommendation result.

In the case where the fifth recommendation strategy is the target recommendation strategy, a fourth initial recommendation result and a fifth initial recommendation result are obtained. In this case, a method of obtaining the fourth initial recommendation result is substantially the same as the above-mentioned method of obtaining the fourth initial recommendation result, except that the score matrix R of the user for the commodity is preset.

In some embodiments, before the step 203, the information recommendation method may further include obtaining the at least one initial recommendation result from a database in which the at least one initial recommendation result is stored in advance according to the target recommendation strategy.

Step 204: fusing the at least one initial recommendation result according to a corresponding weight to obtain a target recommendation result.

In an embodiment, each initial recommendation result has a corresponding weight. A correspondence between the initial recommendation results and the weights may be stored in the server in advance and shown in table 3 below. The table 3 may be looked up by the server according to the initial recommendation result to obtain the corresponding weight. For example, the table 3 is looked up according to the fifth initial recommendation result to obtain the weight C5.

TABLE 3

| Initial Recommendation Result | Weight |
|---|---|
| First Initial Recommendation Result | C1 |
| Second Initial Recommendation Result | C2 |
| Third Initial Recommendation Result | C3 |
| Fourth Initial Recommendation Result | C4 |
| Fifth Initial Recommendation Result | C5 |

In an embodiment, the at least one initial recommendation result may be fused according to the corresponding weight to obtain the target recommendation result. In an exemplary embodiment, in the case where the first recommendation strategy is the target recommendation strategy, the table 2 may be looked up to obtain the first, second and third initial recommendation results, the table 3 may be then looked up to obtain the weights C1, C2 and C3 corresponding to the first, second and third initial recommendation results respectively, and then, the first, second and third initial recommendation results may be fused according to the corresponding weights C1, C2 and C3 to obtain the target recommendation result.

In an exemplary embodiment, the first initial recommendation result may include commodities 1, 2 and 3, the second initial recommendation result may include commodities 1 and 2, the third initial recommendation result may include commodities 1, 3 and 4, C1, C2 and C3 are 0.3, 0.2 and 0.2 respectively, and then, the weights of commodities 1, 2, 3 and 4 obtained after the fusion of the recommendation results are 0.7, 0.5, 0.5 and 0.2 respectively. Then, the fused recommendation results may be sorted, and the specified number of commodities with the highest weights are taken as the target recommendation result. For example, three commodities (commodities 1, 2 and 3) with the highest weights may be taken as the target recommendation result.

In another exemplary embodiment, when the second recommendation strategy is the target recommendation strategy, the table 2 may be looked up to obtain the second and third initial recommendation results, the table 3 may be then looked up to obtain the weights C2 and C3 corresponding to the second and third initial recommendation results respectively, and then, the second and third initial recommendation results may be fused according to the corresponding weights C2 and C3 to obtain the target recommendation result.

In another exemplary embodiment, when the third recommendation strategy is the target recommendation strategy, the table 2 may be looked up to obtain the first, fourth and fifth initial recommendation results, the table 3 may be then looked up to obtain the weights C1, C4 and C5 corresponding to the first, fourth and fifth initial recommendation results respectively, and then, the first, fourth and fifth initial recommendation results may be fused according to the corresponding weights C1, C4 and C5 to obtain the target recommendation result.

In another exemplary embodiment, when the fourth recommendation strategy is the target recommendation strategy, the table 2 may be looked up to obtain the first and fifth initial recommendation results, the table 3 may be then looked up to obtain the weights C1 and C5 corresponding to the first and fifth initial recommendation results respectively, and then, the first and fifth initial recommendation results may be fused according to the corresponding weights C1 and C5 to obtain the target recommendation result.

In another exemplary embodiment, when the fifth recommendation strategy is the target recommendation strategy, the table 2 may be looked up to obtain the fourth and fifth initial recommendation results, the table 3 may be then looked up to obtain the weights C4 and C5 corresponding to the fourth and fifth initial recommendation results respectively, and then, the fourth and fifth initial recommendation results may be fused according to the corresponding weights C4 and C5 to obtain the target recommendation result.

In another exemplary embodiment, when the sixth recommendation strategy is the target recommendation strategy, the table 2 may be looked up to obtain the fifth initial recommendation result, the table 3 may be then looked up to obtain the weight C5 corresponding to the fifth initial recommendation result, and then, the fifth initial recommendation result may be fused according to the weight C5 thereof to obtain the target recommendation result.

In this embodiment, the target recommendation parameter corresponding to the page identifier of the page is determined according to the page identifier; the corresponding target recommendation strategy is determined according to the target recommendation parameter, and the at least one initial recommendation result is obtained according to the target recommendation strategy; the at least one initial recommendation result is fused according to the corresponding weight to obtain the target recommendation result. Since the target recommendation parameter may be determined according to the page, the target recommendation strategy may be determined according to the target recommendation parameter, the at least one initial recommendation result may be determined according to the target recommendation strategy, and the at least one initial recommendation result may be fused according to the corresponding weight to obtain the target recommendation result, pertinence of information recommendation may be improved.

As shown in FIG. 3, at least one embodiment of the present disclosure further provides an information recommendation device, which includes:

a first determining module 31, configured for determining a target recommendation parameter corresponding to a page identifier of a page according to the page identifier and a correspondence between page identifiers and recommendation parameters;

a second determining module 32, configured for determining a corresponding target recommendation strategy according to the target recommendation parameter;

a querying module 33, configured for querying a correspondence between recommendation strategies and recommendation results according to the target recommendation strategy, so as to obtain at least one initial recommendation result; and

a fusing module 34, configured for fusing the at least one initial recommendation result according to a corresponding weight to obtain a target recommendation result.

In this embodiment, the target recommendation parameter corresponding to the page identifier of the page is determined according to the page identifier and a correspondence between page identifiers and recommendation parameters; the corresponding target recommendation strategy is determined according to the target recommendation parameter; the correspondence between the recommendation strategies and the recommendation results is queried according to the target recommendation strategy, so as to obtain the at least one initial recommendation result; the at least one initial recommendation result is fused according to the corresponding weight to obtain the target recommendation result. Since the target recommendation parameter may be determined according to the page, the target recommendation strategy may be determined according to the target recommendation parameter, the at least one initial recommendation result may be determined according to the target recommendation strategy, and the at least one initial recommendation result may be fused according to the corresponding weight to obtain the target recommendation result, pertinence of information recommendation may be improved.

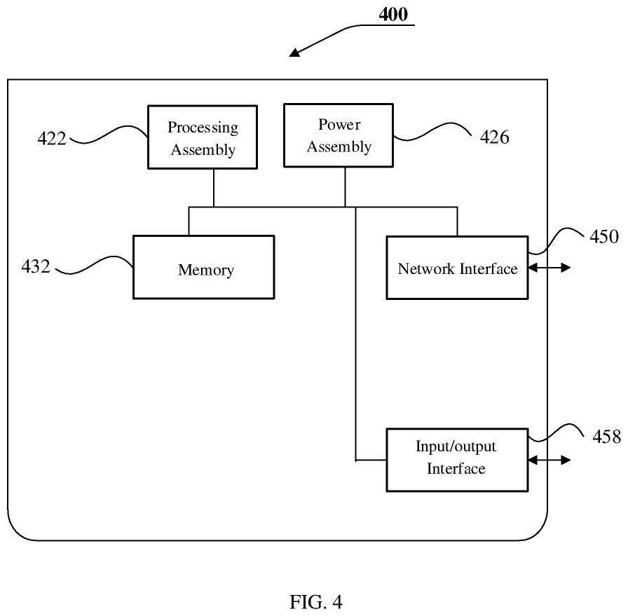

FIG. 4 is a block diagram of an information recommendation device according to one exemplary embodiment. For example, the device 400 may be provided as a server or a user terminal (for example, a mobile phone, a desktop computer, a tablet computer, a notebook computer, etc.). Referring to FIG. 4, the device 400 includes a processing assembly 422 and a memory resource represented by a memory 432, the processing assembly 422 further includes one or more processors, and the memory 432 is configured to store instructions, such as an application, which are executable by the processing assembly 422. The application stored in the memory 432 may include one or more modules each corresponding to a set of instructions. Furthermore, the processing assembly 422 is configured to execute the instructions to perform the above-described control method of adjusting light.

The device 400 may also include a power assembly 426 configured to perform power management of the device 400, a wired or wireless network interface 450 configured to connect the device 400 to a network, and an input/output (I/O) interface 458. The device 400 may be operated based on an operating system stored in the memory 432, such as Windows Server™, Mac OS X™, Unix™, Linux™, FreeBSD™, etc.

An exemplary embodiment further provides a non-transitory computer readable storage medium including instructions, such as the memory 432 including the instructions, and the above-mentioned instructions are executable by the processing assembly 422 of the device 400 to perform the above-mentioned method. For example, the non-transitory computer readable storage medium may be an ROM, a random access memory (RAM), a CD-ROM, a magnetic tape, a floppy disk, an optical data storage apparatus, or the like.

In the present disclosure, terms such as “first” and “second” are only used for the purpose of description and are not intended to indicate or imply relative importance. The term “a plurality of” means two or more than two, unless specified otherwise.

The above description merely relates to exemplary embodiments of the present disclosure and is not intended to limit the protection scope of the present disclosure, which is determined by the appended claims.

1. An information recommendation method, comprising:
determining a target recommendation parameter corresponding to a page identifier of a page, according to the page identifier and a correspondence between a page identifier and a recommendation parameter;
determining a corresponding target recommendation strategy according to the target recommendation parameter;
querying a correspondence between a recommendation strategy and a recommendation result according to the target recommendation strategy, so as to obtain at least one initial recommendation result; and
fusing the at least one initial recommendation result according to a corresponding weight to obtain a target recommendation result.

2. The information recommendation method according to claim 1, wherein
the page is a first recommendation page; and
the target recommendation parameter is a user identifier of a user.

3. The information recommendation method according to claim 2, wherein
the target recommendation strategy is a first recommendation strategy;
the querying the correspondence between the recommendation strategy and the recommendation result according to the target recommendation strategy, so as to obtain the at least one initial recommendation result comprises:
obtaining a first initial recommendation result, a second initial recommendation result and a third initial recommendation result, according to the first recommendation strategy;
wherein the first initial recommendation result is a target recommended to the user according to target preference data of the user corresponding to the user identifier;
the second initial recommendation result is a target recommended to the user according to a tag of the user corresponding to the user identifier; and
the third initial recommendation result is a target recommended to the user according to a put-on-sale time of the target and the user identifier, and the put-on-sale time meets a preset condition.

4. The information recommendation method according to claim 3, wherein
prior to determining the corresponding target recommendation strategy according to the target recommendation parameter, the information recommendation method further comprises:
determining according to the user identifier that user-target interaction behavior data corresponding to the user identifier exists in a preset database, and
the target preference data is obtained according to the user-target interaction behavior data corresponding to the user identifier, and
the user-target interaction behavior data comprises at least one of a group consisting of target purchase behavior data, target commenting behavior data, target sharing behavior data, target collecting behavior data, target likes-giving behavior data, target browsing behavior data and target pushing behavior data.

5. The information recommendation method according to claim 2, wherein
the target recommendation strategy is a second recommendation strategy;
the querying the correspondence between the recommendation strategy and the recommendation result according to the target recommendation strategy, so as to obtain the at least one initial recommendation result comprises:
obtaining a second initial recommendation result and a third initial recommendation result, according to the second recommendation strategy;
wherein the second initial recommendation result is a target recommended to the user according to a tag of the user corresponding to the user identifier; and
the third initial recommendation result is a target recommended to the user according to a put-on-sale time of the target and the user identifier, and the put-on-sale time meets a preset condition.

6. The information recommendation method according to claim 5, wherein
prior to determining the corresponding target recommendation strategy according to the target recommendation parameter, the information recommendation method further comprises:
determining according to the user identifier that user-target interaction behavior data corresponding to the user identifier is absent in a preset database, and
the user-target interaction behavior data comprises at least one of a group consisting of target purchase behavior data, target commenting behavior data, target sharing behavior data, target collecting behavior data, target likes-giving behavior data, target browsing behavior data and target pushing behavior data.

7. The information recommendation method according to claim 1, wherein
the page is a second recommendation page; and
the target recommendation parameter comprises a target identifier and a user identifier of a user.

8. The information recommendation method according to claim 7, wherein
the target recommendation strategy is a third recommendation strategy;
the querying the correspondence between the recommendation strategy and the recommendation result according to the target recommendation strategy, so as to obtain the at least one initial recommendation result comprises:
obtaining a first initial recommendation result, a fourth initial recommendation result and a fifth initial recommendation result, according to the third recommendation strategy;
wherein the first initial recommendation result is a target recommended to the user according to target preference data of the user corresponding to the user identifier;
the fourth initial recommendation result is a target recommended to the user according to a rut correspondence between the target identifier and a target identifier of a similar target, and the target preference data and the first correspondence are obtained according to user-target interaction behavior data corresponding to the user identifier; and
the fifth initial recommendation result is a target recommended to the user according to the target identifier and a second correspondence between the target identifier and a target identifier of a similar target, and the second correspondence is obtained by calculating a similarity between targets according to attribute data of the targets; and
the user-target interaction behavior data comprises at least one of a group consisting of target purchase behavior data, target commenting behavior data, target sharing behavior data, target collecting behavior data, target likes-giving behavior data, target browsing behavior data and target pushing behavior data.

9. The information recommendation method according to claim 8, wherein
prior to determining the corresponding target recommendation strategy according to the target recommendation parameter, the information recommendation method further comprises:
determining according to the user identifier that the user-target interaction behavior data corresponding to the user identifier exists in a preset database; and
determining according to the target identifier that target interaction behavior data corresponding to the target identifier exists in a preset database, and
the target interaction behavior data comprises at least one of a group consisting of target purchase behavior data, target commenting behavior data, target sharing behavior data, target collecting behavior data, target likes-giving behavior data, target browsing behavior data and target pushing behavior data.

10. The information recommendation method according to claim 7, wherein
the target recommendation strategy is a fourth recommendation strategy;
the querying the correspondence between the recommendation strategy and the recommendation result according to the target recommendation strategy, so as to obtain the at least one initial recommendation result comprises:
obtaining a first initial recommendation result and a fifth initial recommendation result, according to the fourth recommendation strategy;
wherein the first initial recommendation result is a target recommended to the user according to target preference data of the user, and the target preference data is obtained by inputting user-target interaction behavior data into a trained recommendation model; and
the fifth initial recommendation result is a target recommended to the user according to the target identifier and a second correspondence between the target identifier and a target identifier of a similar target, and the second correspondence is obtained by calculating a similarity between targets according to attribute data of the targets; and
the user-target interaction behavior data comprises at least one of a group consisting of target purchase behavior data, target commenting behavior data, target sharing behavior data, target collecting behavior data, target likes-giving behavior data, target browsing behavior data and target pushing behavior data.

11. The information recommendation method according to claim 10, wherein
prior to determining the corresponding target recommendation strategy according to the target recommendation parameter, the information recommendation method further comprises:
determining according to the user identifier that the user-target interaction behavior data corresponding to the user identifier exists in a preset database; and
determining according to the target identifier that target interaction behavior data corresponding to the target identifier is absent in a preset database, and
the target interaction behavior data comprises at least one of a group consisting of target purchase behavior data, target commenting behavior data, target sharing behavior data, target collecting behavior data, target likes-giving behavior data, target browning behavior data and target pushing behavior data.

12. The information recommendation method according to claim 7, wherein
the target recommendation strategy is a fifth recommendation strategy;
the querying the correspondence between the recommendation strategy and the recommendation result according to the target recommendation strategy, so as to obtain the at least one initial recommendation result comprises:
obtaining a fourth initial recommendation result and a fifth initial recommendation result, according to the fifth recommendation strategy;
wherein the fourth initial recommendation result is the target recommended to the user according to a first correspondence between the target identifier and a target identifier of a similar target, and the first correspondence is obtained according to user-target interaction behavior data corresponding to the user identifier; and
the fifth initial recommendation result is a target recommended to the user according to the target identifier and a second correspondence between the target identifier and a target identifier of a similar target, and the second correspondence is obtained by calculating a similarity between targets according to attribute data of the targets; and
the user-target interaction behavior data comprises at least one of a group consisting of target purchase behavior data, target commenting behavior data, target sharing behavior data, target collecting behavior data, target like-giving behavior data, target browsing behavior data and target pushing behavior data.

13. The information recommendation method according to claim 12, wherein
prior to determining the corresponding target recommendation strategy according to the target recommendation parameter, the information recommendation method further comprises:
determining according to the user identifier that user-target interaction behavior data corresponding to the user identifier is absent in a preset database; and
determining according to the target identifier that target interaction behavior data corresponding to the target identifier exists in a preset database, and
the target interaction behavior data comprises at least one of a group consisting of target purchase behavior data, target commenting behavior data target sharing behavior data, target collecting behavior data, target likes-giving behavior data, target browsing behavior data and target pushing behavior data.

14. The information recommendation method according to claim 7, wherein
the target recommendation strategy is a sixth recommendation strategy;
the querying the correspondence between the recommendation strategy and the recommendation result according to the target recommendation strategy, so as to obtain the at least one initial recommendation result comprises:
obtaining a fifth initial recommendation result according to the sixth recommendation strategy;
wherein the fifth initial recommendation result is a target recommended to the user according to the target identifier and a second correspondence between the target identifier and a target identifier of a similar target, and the second correspondence is obtained by calculating a similarity between targets according to attribute data of the targets.

15. The information recommendation method according to claim 14, wherein
prior to determining the corresponding target recommendation strategy according to the target recommendation parameter, the information recommendation method further comprises:
determining according to the user identifier that user-target interaction behavior data corresponding to the user identifier is absent in a preset database; and
determining according to the target identifier that target interaction behavior data corresponding to the target identifier is absent in a preset database,
the user-target interaction behavior data comprises at least one of a group consisting of target purchase behavior data, target commenting behavior data, target sharing behavior data, target collecting behavior data, target likes-giving behavior data, target browsing behavior data and target pushing behavior data, and
the target interaction behavior data comprises at least one of a group consisting target purchase behavior data, target commenting behavior data, target haring behavior data, target collecting behavior data, target likes-giving behavior data, target browsing behavior data and target pushing behavior data.

16-17. (canceled)

18. The information recommendation method according to claim 1, wherein the querying the correspondence between the recommendation strategy and the recommendation result according to the target recommendation strategy, so as to obtain the at least one initial recommendation result comprises:
obtaining the at least one initial recommendation result from a database according to the target recommendation strategy, wherein the at least one initial recommendation result is stored in the database in advance.

19. An information recommendation device, comprising:
a first determining circuit configured to determine a target recommendation parameter corresponding to a page identifier of a page, according to the page identifier and a correspondence between a page identifier and a recommendation parameter;
a second determining circuit configured to determine a corresponding target recommendation strategy according to the target recommendation parameter;
a querying circuit configured to query a correspondence between a recommendation strategy and a recommendation result according to the target recommendation strategy, so as to obtain at least one initial recommendation result; and
a fusing circuit configured to fuse the at least one initial recommendation result according to a corresponding weight to obtain a target recommendation result.

20. An information recommendation device, comprising:
a processor; and
a memory,
wherein the memory is configured to store instructions, and the instructions, when executed by the processor, cause the processor to execute operations comprising:
determining a target recommendation parameter corresponding to a page identifier of a page, according to the page identifier and a correspondence between a page identifier and a recommendation parameter;
determining a corresponding target recommendation strategy according to the target recommendation parameter;
querying a correspondence between a recommendation strategy and a recommendation result according to the target recommendation strategy, so as to obtain at least one initial recommendation result; and
fusing the at least one initial recommendation result according to a corresponding weight to obtain a target recommendation result.

21. A non-transitory computer storage medium configured to store instructions, the instructions, when executed by a processor, causing the processor to execute the information recommendation method according to claim 1.

22. The information recommendation method according to claim 2, wherein the querying the correspondence between the recommendation strategy and the recommendation result according to the target recommendation strategy, so as to obtain the at least one initial recommendation result comprises:
obtaining the at least one initial recommendation result from a database according to the target recommendation strategy, wherein the at least one initial recommendation result is stored in the database in advance.
